(19) United States
(12) Patent Application Publication
(10) Pub. No.: US 2009/0125553 A1
(43) Pub. Date: May 14, 2009

(54) ASYNCHRONOUS PROCESSING AND FUNCTION SHIPPING IN SSIS

(75) Inventor: Grant Dickinson, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/939,645

(22) Filed: Nov. 14, 2007

(51) Int. Cl. G06F 17/30

(52) U.S. Cl. 707/104.1; 707/E17.01

(57) ABSTRACT

Systems and methods that integrate data and business logic/functions associated with a data flow. An encapsulation component packages data flow and business logic together as part of a message based asynchronous execution. Such encapsulation component spans a single logical data flow across multiple servers and supports distributed processing, wherein by serializing the function and logic and encapsulating a message in conjunction with data, a unit of work that requires completion can be sent in the message to a server as part of a plurality of servers.

### BACKGROUND

Increasing advances in computer technology (e.g., microprocessor speed, memory capacity, data transfer bandwidth, software functionality, and the like) have generally contributed to increased computer application in various industries. Ever more powerful server systems, which are often configured as an array of servers, are often provided to service requests originating from external sources such as the World Wide Web, for example. As local Intranet systems have become more sophisticated thereby requiring servicing of larger network loads and related applications, internal system demands have grown accordingly as well. Simultaneously, the use of data analysis tools has increased dramatically as society has become more dependent on databases and similar digital information storage mediums. Such information is typically analyzed, or “mined,” to learn additional information regarding customers, users, products, and the like.

As such, much business data is stored in databases, under the management of a database management system (DBMS). A large percentage of overall new database applications have been in a relational database environment. Such relational database can further provide an ideal environment for supporting various forms of queries on the database. Accordingly, the use of relational and distributed databases for storing data has become commonplace, with the distributed databases being databases wherein one or more portions of the database are divided and/or replicated (copied) to different computer systems and/or data warehouses.

A data warehouse is a nonvolatile repository that houses an enormous amount of historical data rather than live or current data. The historical data can correspond to past transactional or operational information. Moreover, Data Extraction, Transformation and Load (ETL) is critical in any data warehousing scenario. Within SQL Server Integration Services (SSIS), the core ETL functions are performed within ‘Data Flow Tasks’. Data flows in SSIS can be built by employing components that define the sources that data comes from, the destinations it gets loaded to, and the transformations applied to data during the transfer. Typically, such components have to be configured by defining their metadata.

In general, data Flow architecture in SSIS is monolithic, in the sense that a single logical Data Flow cannot span multiple computers. Such can create complexities when creating scale-out solutions that take better advantage of server arrays, for example.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation integrates data and business logic/functions associated with a data flow via an encapsulation component that packages them together as part of a message-based asynchronous execution. Such encapsulation component spans a single logical data flow across multiple servers and supports distributed processing, wherein by serializing the function and logic and encapsulating a message in conjunction with data, a unit of work that requires completion can be sent in the message to a server as part of a plurality of servers. Such can further facilitate a scale out of complex operations and automatically distribute functionality across boundaries (e.g., to package up a section of the Data Flow—‘function’—and ship it off to another computer to process)—wherein a remote function can access its data within its immediate process and security context (e.g., mitigating a requirement for establishing a connection task back to the function shipper.)

In a related aspect, a data stream with actual data therein includes a package (or fragment of a package) that is serialized in the XML, and such data stream includes business logic in front of the header. As such, a tightly coupled logic can be provided to support a distributed processing, wherein the data stream can be partitioned into various sections or chunks, by positioning the business logic at the header of each section and subsequently transmitting to a plurality of servers. Such an arrangement enables a server to process a segment of the data. Upon completion of the processing for one segment, each segment or fragment can forward the processing result to other fragments. Hence, data that belongs to such unit of work can be sent in a message to a server, so that the data and the business logic can be packaged together and automatically distributed over multiple machines. The modular and distributed Data Flow design paradigm of the subject innovation facilitates standardized processes around designing and deploying Extraction, Transformation, and load (ETL) logic, to enable central storage of Flowlet libraries, simple scale-out and easier maintenance.

According to a related methodology, an orchestrating server can manage operation of other servers—wherein one server can enter a planning mode and take the package and analyze it as a graph for decomposing thereof. Such server can communicate with another machine upon processing a parsed fragment. Hence, a package can be decomposed and sent to various servers, wherein data flows in SSIS can initially be broken down into sub-graphs (e.g., Dataflows in SSIS are Directed Acyclic Graphs—DAGs—and hence they can be analyzed and manipulated using graph theory). Such break down of data flows can be treated in a modular fashion (non-monolithic) manner, and can occur through manual decomposition or automatic decomposition. Subsequently, a data flow can be defined in terms of multiple flowlets, and during a planning stage a decision can be made as to which fragment needs to be shipped and/or replicated to remote locations, using distributed processing heuristics. Moreover, a decision can be made as to whether the data that the fragment requires can be accessed remotely (e.g., the fragment can connect directly to the data source itself) or if it should be shipped (e.g., the data is shipped with the fragment). Subsequently, the data flow can be executed.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an encapsulation component that integrates data and business logic in accordance with an aspect of the subject innovation.

FIG. 2 illustrates a further block diagram of an encapsulation component that further includes a decomposition component in accordance with a further aspect of the subject innovation.

FIG. 3 illustrates a further exemplary aspect of the subject innovation, wherein the encapsulation component further comprises a planning component and an execution component.

FIG. 4 illustrates a related methodology of integrating business logic/in accordance with an aspect of the subject innovation.

FIG. 5 illustrates a further methodology of packaging a dataflow as part of a message based asynchronous prosecution in accordance with an aspect of the subject innovation.

FIG. 6 illustrates an artificial intelligence component that can interact with the encapsulation component to facilitate integration of data and business logic in accordance with an aspect of the subject innovation.

FIG. 7 illustrates an exemplary packaging format, wherein data can be transported in a binary format similar to the SSIS Raw File format.

FIG. 8 illustrates exemplary fragments that are decomposed and executed in accordance with an aspect of the subject innovation.

FIG. 9 illustrates an exemplary block diagram of a system for modularizing data flows according to one aspect of the subject innovation.

FIG. 10 illustrates a schematic block diagram of a suitable operating environment for implementing aspects of the subject innovation.

FIG. 11 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

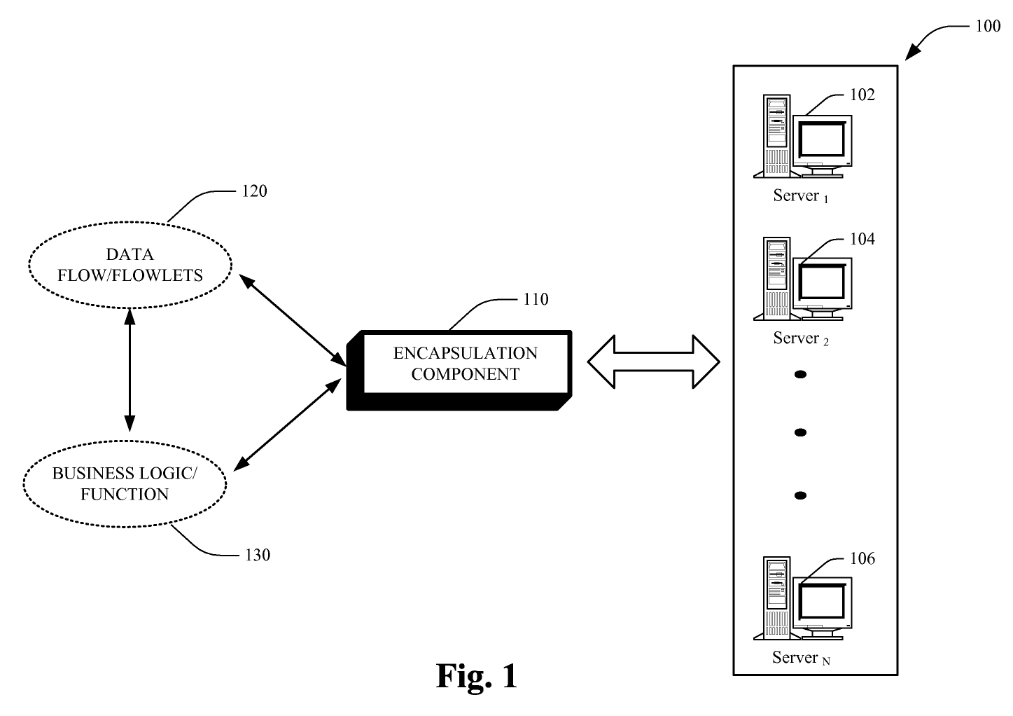

FIG. 1 illustrates a system 100 that integrates data and business logic/functions 130 associated with data flow/flowlets 120 via an encapsulation component 110 in accordance with an aspect of the subject innovation. The encapsulation component 110 packages the data and business logic functions together as part of message based asynchronous execution on servers 102, 104, 106 for example. The encapsulation component 110 spans a single logical data flow across multiple servers 102, 104, 106 and supports distributed processing, wherein by serializing the function and logic and encapsulating a message in conjunction with a suitable partition of data, a unit of work that requires completion can be sent in the message to a server as part of a plurality of servers 102, 104, 106.

In one particular aspect, the data flow 120 can be associated with data flow tasks for Data Extraction, Transformation and Load (ETL). In general, the ETL process begins when data is extracted from specific data sources (not shown). The data is then transformed, using rules, algorithms, concatenations, or any number of conversion types, into a specific state. Once in this state, the transformed data can be loaded into the Data Warehouse (not shown) where it can be accessed for use in analysis and reporting. The data warehouse can access a variety of sources, including SQL server, flat files, and facilitates end user decision making, since such data warehouse can be a data mart that contains data optimized for end user decision analysis. Additionally, operations relating to data replication, aggregation, summarization, or enhancement of the data; can be facilitated via various decision support tools associated with the data warehouse. Furthermore, a plurality of business views that model structure and format of data can be implemented using an interface associated with the data warehouse. In such environments, the SSIS core ETL functions are performed within ‘Data Flow Tasks’. Data flows in SSIS can be built using components that define the sources that data comes from, the destinations it gets loaded to, and the transformations applied to data during the transfer.

Moreover, data flow/flowlet can have one or more source or destination points that are unknown or are unavailable, can have one or more operations within the flow that are unknown, or a combination thereof. Flowlets can address the above problems and can allow an iterative approach in building SSIS data flows, by allowing pieces of the data flow logic to be built and tested separately through a stand-alone execution process.

Furthermore, flowlets can consist of single or many data flow components configured to process data sets defined by its published metadata. These components can form a common logic that can be used and reused in many different data flows. The modular data flow design paradigm enabled by flowlets can further help standardize processes around designing and deploying ETL logic, allow central storage of flowlet libraries, and provides ease of maintenance. Furthermore, flowlets can be managed, deployed, executed, and tested with great flexibility and modularity in accordance with the disclosed embodiments to allow efficient and convenient reuse of portions of data flow logic. The encapsulation component 110 can further facilitate a scale out of complex operations and automatically distribute functionality across boundaries (e.g., to package up a section of the Data Flow—‘function’—and ship it off to another computer to process)—wherein a remote function can access its data within its immediate process and security context e.g., mitigating a requirement for establishing a connection task back to the function shipper.)

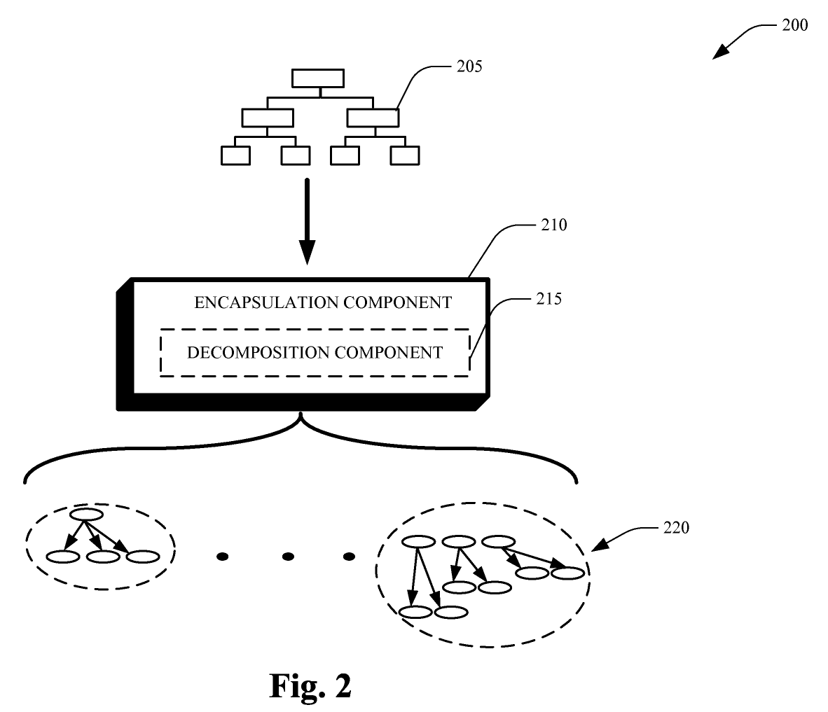

FIG. 2 illustrates an encapsulation component 210 that includes a decomposition component 215 in accordance to a further aspect of the subject innovation. In general, Dataflows in SSIS are in form of Directed Acyclic Graphs (DAGs) 205, and as such they can be analyzed and manipulated using graph theory. As illustrated in FIG. 2 one aspect of the subject innovation involves shipping functions, wherein the Data Flow is broken down into sub-graphs 220 so that it can be treated in a modular (non-monolithic) manner. The decomposition component 215 can operate based on either manual decomposition or an automatic decomposition.

In manual decomposition, the user can explicitly define the Data Flow subgraphs 205 by using the concept of Flowlets, as described in detail infra. Such flowlets enable a user to break apart a Data Flow at design time and then persist each fragment separately in order to promote code re-use. Moreover, at runtime the fragments can be reconstituted into a traditional monolithic Data Flow. Likewise, for an automatic decomposition and to convert sequential program into parallel one, the steps that can be performed in parallel, and steps that require communications between different nodes can be identified. Moreover, different heuristics can be employed to identify each step and/or act. Such heuristics can typically preserve correctness of business logic inside data flow, wherein a re-write can be employed to implement distributed algorithms (e.g., instead of equivalent sequential ones, such can result in a higher scalable performance). Application of different heuristics can produce different distributed execution plans, and an optimal plan can thus be selected by examining ratio of benefits to costs. As explained earlier, the graph can be automatically cut into sub-graphs 220 by employing Flowlets technology. The algorithms for performing such decomposition are well known, for instance a monolithic sort operation on a large amount of data can be decomposed into multiple concurrent sorts of subsets of data that are later merged back together using a merge-sort operation. It is to be appreciated that the decomposition technology can include the ability to partition the data into required subsets—for instance predicates in the source components or queries can be translated into data partition definitions so that the smallest required amount of data is co-shipped with the function.

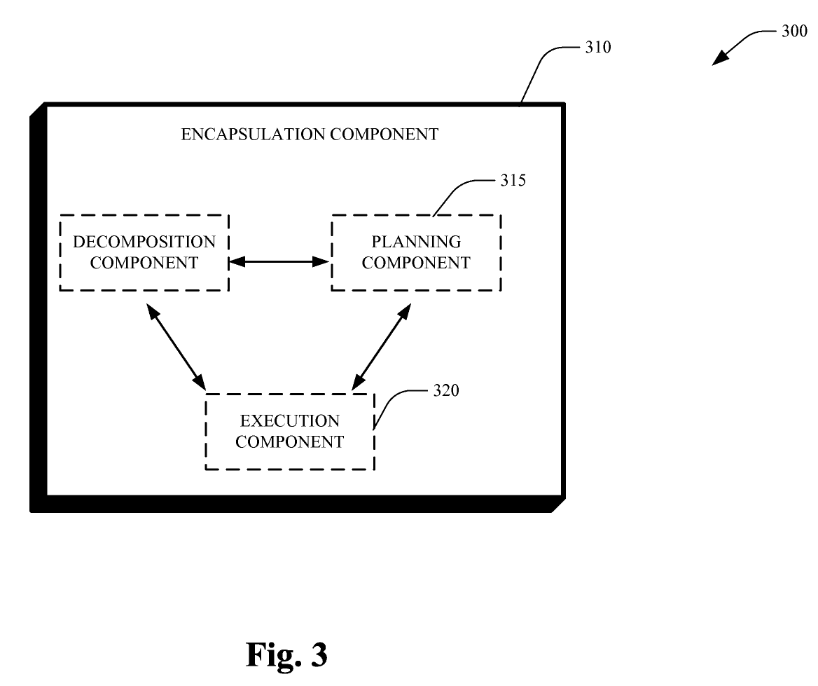

FIG. 3 illustrates a further exemplary aspect of the subject innovation, wherein the encapsulation component 310 further comprises a planning component 315 and an execution component 320. The planning component 315 can determine which fragments are required to be shipped and/or replicated to remote locations, via employing distributed processing heuristics. For example, a fragment that performs a sorting operation can be a suitable candidate to replicate to five destinations. Moreover, a decision can be made as to whether the data that the fragment requires can be accessed remotely (e.g., the fragment can connect directly to the data source itself) or if it can be shipped (e.g., the data is shipped with the fragment). Also, the data can be appropriately portioned into smaller subsets—for instance using the previous example, each of the 5 destinations can receive one fifth of the data to sort.

The execution component 320 can build a distributed dataflow by initially executing each fragment autonomously—e.g., by typically not reconstituting subgraphs back into the original graph (in the manner that Flowlets reconstitute). As the next fragment is required to execute, such fragment can be serialized into a binary or textual format, wherein variables can be serialized in conjunction with security or environment information that the fragment requires. Moreover, if the heuristics requires that the data is shipped, then data can be packaged up in an efficient binary format; and/or details of the connection (including credentials, and the like). The partition definition can also be packaged, wherein if a fragment is being replicated or split a predetermined number of times (e.g., five times) for scale-out purposes, then the segment of data that each fragment should typically operate on can be specified. Moreover, in cases that the data is co-shipped, such may not be required as each fragment can ship its corresponding partition only. It is to be appreciated the source and destination terminator(s) in each fragment can typically know how to read and write to the serialized data format, and/or well as the source database, depending on how they are configured, for example. A message can then be sent to a remote computer, whereupon the fragment is instantiated and executed within the context of the variables and data that is passed to it. Moreover, some fragment can be annotated as being single-instance, wherein such fragments can have multiple inputs.

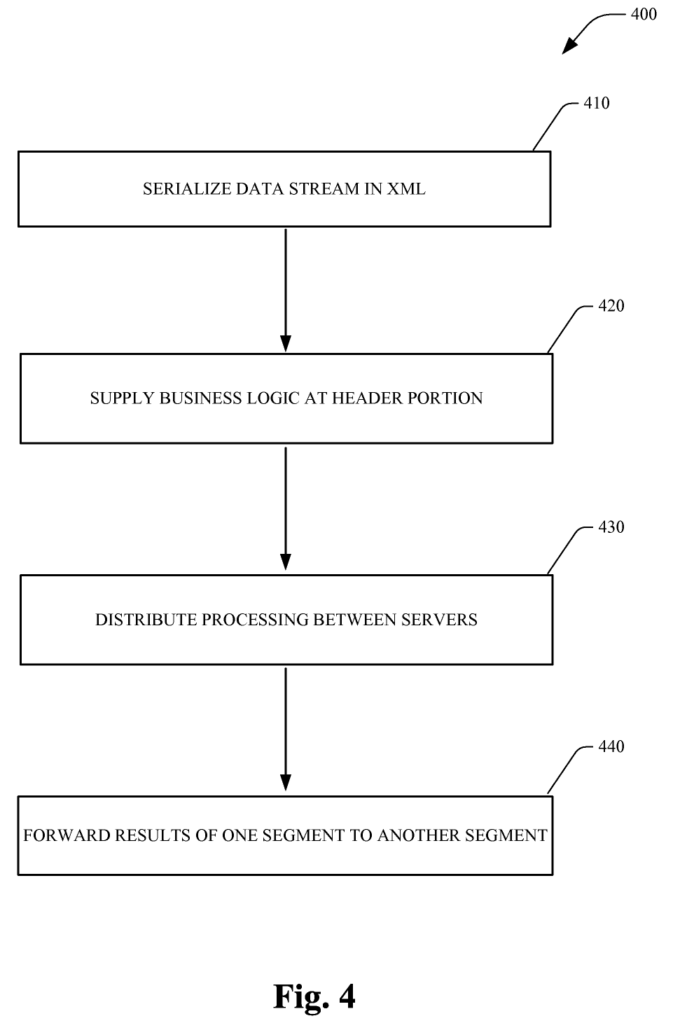

FIG. 4 illustrates a related methodology 400 of integrating business logic/in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 410 a data stream with actual data therein that includes a package, can be serialized in the XML, wherein such data stream includes business logic in front of the head. As such, a tightly coupled logic can be provided to support a distributed processing, wherein the data stream can be partitioned into various sections or chunks, by positioning the business logic at the header of each section at 420, and subsequently transmitting to a plurality of servers. Such an arrangement enables a server to process a segment of the data, and distribute processing between servers at 430. Upon completion of the processing for one segment, each segment or fragment can forward the processing result to other fragments, at 440. Hence, data that belongs to such unit of work can be sent in a message to a server, so that a package and the business logic can be packaged together and automatically distribute over multiple machines.

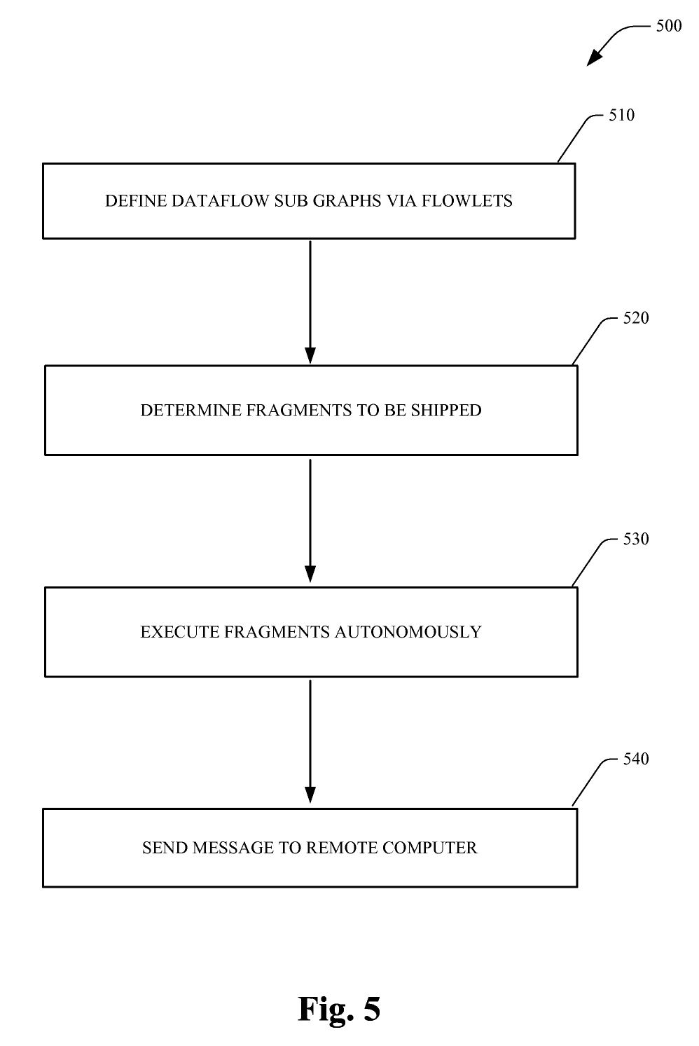

FIG. 5 illustrates a further methodology 500 of packaging a dataflow as part of a message based asynchronous prosecution in accordance with an aspect of the subject innovation. Initially and at 510 subgraphs associated with dataflows can be defined. Such flowlets enable a user to break apart a Data Flow at design time and then persist each fragment separately in order to promote code re-use. Subsequently and at 520 a determination can be performed as to which fragments are required to be shipped and/or replicated to remote locations, via employing distributed processing heuristics. Next, and at 530 each fragment can be built autonomously, wherein as the fragment is required to execute, such fragment can be serialized into a binary or textual format. A message can then be sent at 540 to a remote computer, whereupon the fragment is instantiated and executed within the context of the variables and data that is passed with it in the same message. Moreover, some fragment can be annotated as being single-instance, wherein such fragments can have multiple inputs.

In a related aspect artificial intelligence (AI) components can be employed to facilitate detect of outlier data in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

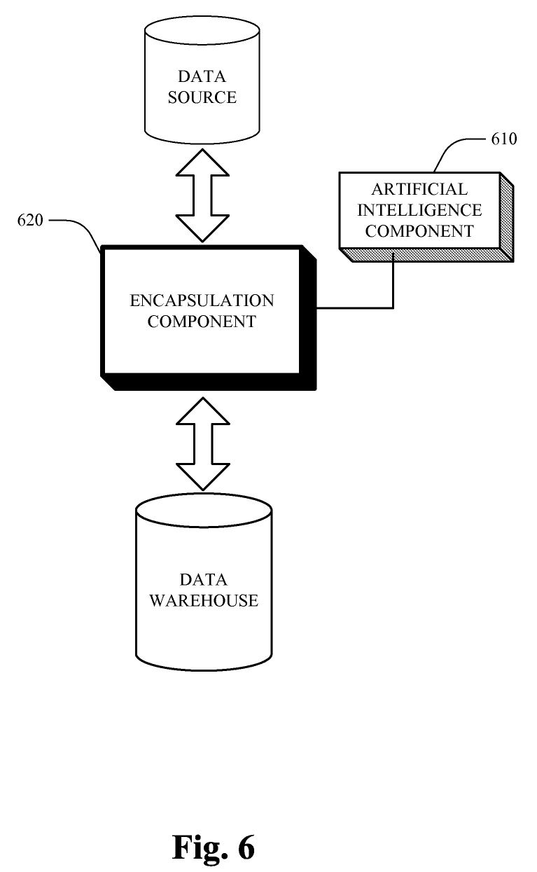

FIG. 6 illustrates an artificial intelligence component 610 that can interact with the encapsulation component 620 to facilitate integration of data and business logic in accordance with an aspect of the subject innovation. For example, a process for scaling out of complex operations and automatically distributing functionalities across boundaries can be facilitated via an automatic classifier system and process. A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed, and at what time to implement tighter criteria controls.

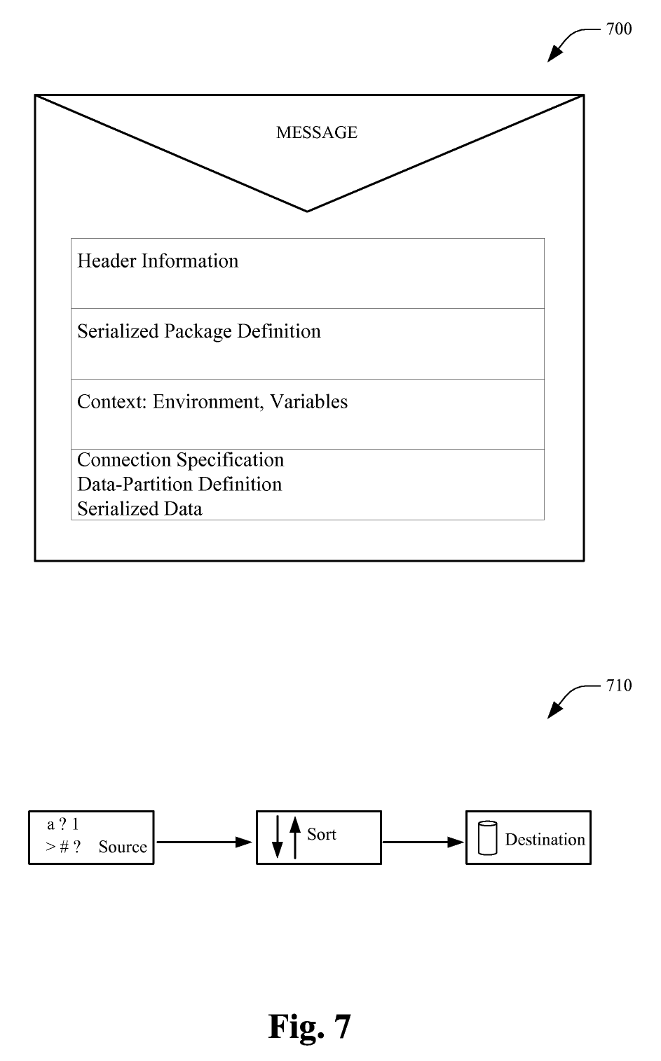

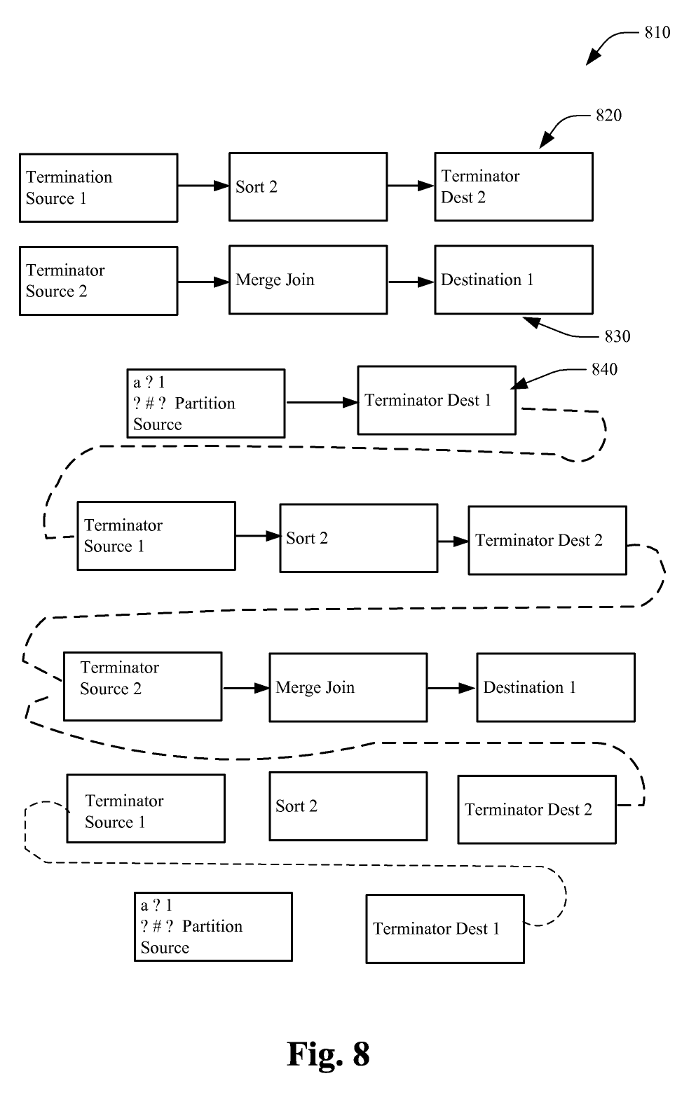

FIG. 7 illustrates an exemplary packaging format, wherein data can be transported in a binary format similar to the SSIS Raw File format. Typically, a subgraph is similar to a Flowlet and so it can be readily serialized. For example, 710 illustrates a simple package, and a source reading data from two source files in serial, wherein the subject innovation can then sort the data, followed by writing it to another database. In such case it can be beneficial to read the two source files at the same time, and then sort them in parallel before writing them to the destination database. After the decomposition act of the subject innovation, as described in detail supra, the fragments 810, 820, 830 of FIG. 8 can be obtained. Fragment A is illustrated by 810, which Reads data from a single text source, and writes the data to a special Terminator destination component. Similarly, 820 indicates Fragment B, which Reads data from a special Terminator source, sorts the data, and then writes to a special Terminator destination.

Fragment C, 830, Reads data from a special Terminator source, merges separate streams together and then writes to a database, wherein a merge-join operation (such as the SSIS MergeJoin component) can be injected as part of the decomposition act. Upon completion of the planning act, a distributed plan can be obtained. It is to be appreciated that such is a mere plan and the fragments are not physically distributed on the computer. Each box can designate a separate computer, and in the example of FIG. 8 each computer can run a single fragment. Accordingly, two instances of Fragment A, two instances of Fragment B and one instance of Fragment C can be obtained. Moreover, Fragment C utilizes two inputs, wherein a merge join operation in the fragment, and the dotted lines indicate the distributed path that the data has to follow. As explained earlier, during the execution stage packages can be executed. The two instances of Fragment A can be executed on machine 1 and 5, wherein each one is instantiated with a constraint that specifies which file (or data partition) should be read from. Moreover, each instance is aware that it requires a Fragment B instance downstream—so each instance can serialize Fragment B into a message and sends the message to the appropriate computer. Moreover, relevant data can also be streamed into the same message. In this example, SQL Server Service Broker (or Microsoft Message Queue—MSMQ) can be employed, to send the message since it provides a reliable store-and-forward queuing platform. As such, the remote computer instantiates the Fragment (which happens to be Fragment B) contained in the message and the source component then reads the data from the same message, or it employs a communications mechanisms to read the data from the first fragment's destination component or the original database. Moreover, each instance of Fragment B is aware that it requires a shared Fragment C instance downstream, so each instance serializes Fragment C into a message and sends the message to the appropriate computer. Such can also stream the relevant data into the same message. Because the subgraph for Fragment C illustrates that it is a single instance with multiple inputs, an attribute on the fragment can cause only one instance to be instantiated, and for the execution to delay until both inputs are ready.

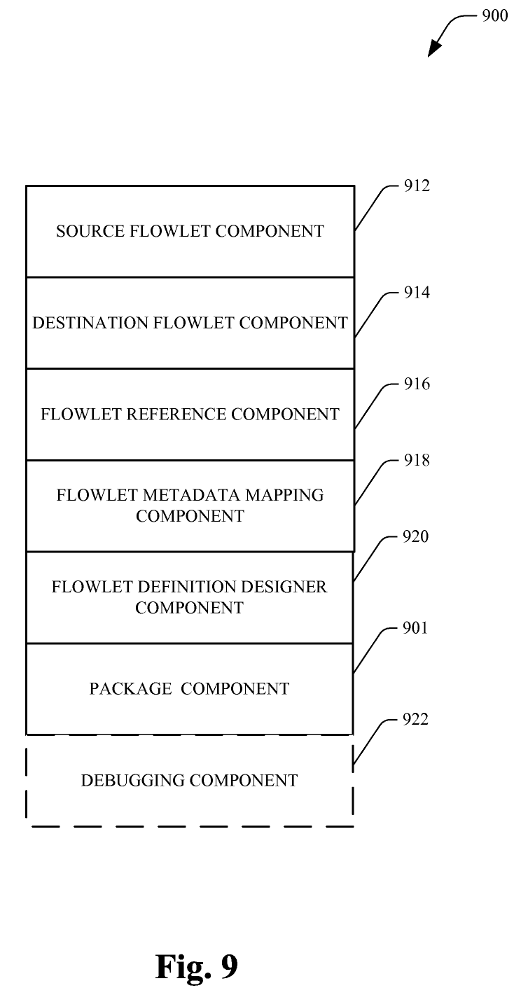

FIG. 9 illustrates an exemplary block diagram of a system for modularizing data flows according to one aspect of the subject innovation. The system 900 can include: a source flowlet component 912 that can provide a functional data source in the data flow logic portion; a destination flowlet component 914, which can provide a functional data destination in the data flow logic portion; a flowlet reference component 916 which can supply link the data flow logic portion to one or more external data flows (not shown); a flowlet metadata mapping component 918 configured to map one or more of the inputs or outputs from the one or more external data flows by mapping source 912 and destination 914 flowlet component inputs or outputs to the flowlet reference component. In addition, the system can 900 include a flowlet definition designer component 920 configured to enable at least one of the creation, editing, use, browsing, and a package component 901 configured to hold a modularized data flow logic portion for at least one of modularized data flow development or deployment. The system can further contain other components such as a debugging component 922. As such, the subject innovation enables spanning a single logical data flow across multiple servers and supports distributed processing, wherein by serializing the function and logic and encapsulating a message in conjunction with data, a unit of work that requires completion can be sent in the message to a server as part of a plurality of servers.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

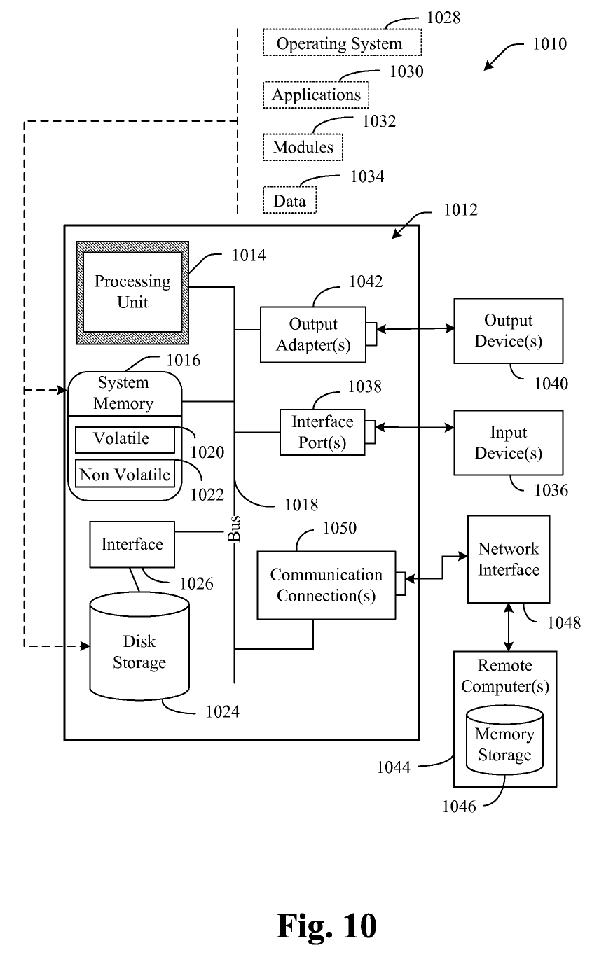

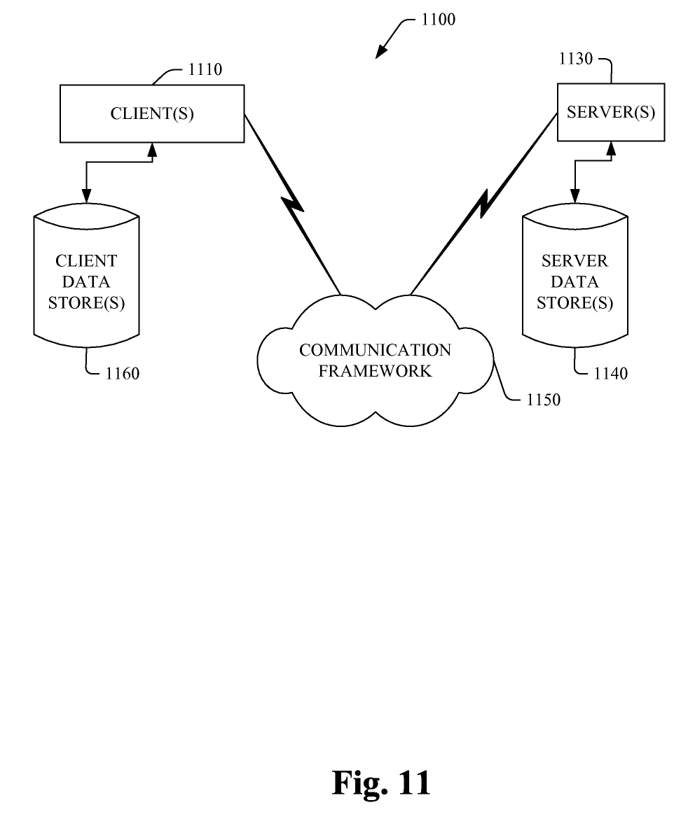

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 10, an exemplary environment 1010 for implementing various aspects of the subject innovation is described that includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates a disk storage 1024, wherein such disk storage 1024 includes, but is not limited to, devices like a magnetic disk drive, floppy disk drive, tape drive, Jaz drive, Zip drive, LS-60 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 that can be employed as part of a processing and function shipping in accordance with an aspect of the subject innovation. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a data flow(s) as part of Server Integration Services (SSIS); and
an encapsulation component that integrates business logic or functions associated with the data flow(s), as part of a message based asynchronous execution.

2. The computer implemented system of claim 1 further comprising a decomposition component as part of the encapsulation component, the decomposition component breaks down the data flow into fragments.

3. The computer implemented system of claim 2 further comprising a planning component that determines fragments to be shipped or replicated to remote locations.

4. The computer implemented system of claim 3 further comprising an execution component that executes fragments autonomously.

5. The computer implemented system of claim 4 further comprising an artificial intelligence component that facilitates integration of data with associated business logic.

6. The computer implemented system of claim 5 further comprising a server as part of a plurality of servers that receives a unit of a work from the processing component.

7. The computer implemented system of claim 2, results for execution of the fragments shareable therebetween.

8. The computer implemented system of claim 2 further comprising a modular distributed data flow design that facilitates standardized deployment of Extraction, Transformation and Load (ETL) logic.

9. The computer implemented system of claim 2, the data flow in form of Directed Acylic Graphs.

10. A computer implemented method comprising:
partitioning a data stream into fragments via positioning a business logic at a header portion,
distributing fragments between a plurality of servers; and
asynchronously processing the fragments as part of a message based execution.

11. The computer implemented system of claim 10 further comprising serializing functions and logic of a data flow associated with the data stream.

12. The computer implemented system of claim 11 further comprising spanning a single logical flow across multiple servers.

13. The computer implemented system of claim 12 further comprising serializing a package into an XML format.

14. The computer implemented system of claim 12 further comprising packaging a business logic, context and associated data together.

15. The computer implemented system of claim 12 further comprising analyzing the data stream through graph theory.

16. The computer implemented system of claim 12 further comprising defining a data flow in terms of multiple flowlets.

17. The computer implemented system of claim 12 further comprising accessing a data source associated with the fragments remotely.

18. The computer implemented system of claim 12 further comprising determining fragments that are to be shipped.

19. The computer implemented system of claim 12 further comprising employing heuristics to facilitate business logic and data.

20. A computer implemented system comprising:
means for defining a data flow(s) as part of Server Integration Services (SSIS); and
means for integrating business logic or functions associated with the data flow(s).
